(19) United States
(12) Patent Application Publication
(10) Pub. No.: US 2025/0269945 A1
(43) Pub. Date: Aug. 28, 2025

(54) ROBOT

(71) Applicant: HONDA MOTOR CO., LTD., Tokyo (JP)

(72) Inventors: Ryo Yamaguchi, Wako-shi (JP); Susumu Miyazaki, Wako-shi (JP)

(21) Appl. No.: 19/053,489

(22) Filed: Feb. 14, 2025

(30) Foreign Application Priority Data
Feb. 22, 2024 (JP) 2024-025864

(51) Int. Cl. B63G 8/22; B63G 8/00

(52) U.S. Cl. CPC B63G 8/22; B63G 2008/002

(57) ABSTRACT

A robot includes a first portion and a second portion coupled to each other. The second portion includes a moving member that is moved for changing at least any of the center of buoyancy and the center of gravity in the robot as whole, and a drive unit that moves the moving member by two-dimensional translation motion. The drive unit includes a power source that outputs power for moving the moving member and is fixed to the first portion.

### CROSS-REFERENCE TO RELATED APPLICATION

Priority is claimed on Japanese Patent Application No. 2024-025864, filed in Japan on Feb. 22, 2024, the entire content of which is incorporated herein by reference.

### BACKGROUND OF THE INVENTION

### Field of the Invention

The present invention relates to a robot.

### Description of Related Art

Conventionally, for example, an underwater robot that includes a float driven by a link mechanism and the like to control a posture such as a pitch angle and a roll angle is known (refer to, for example, Non-Patent Document 1 mentioned below).
[Non-Patent Document 1] Norimitsu Sakagami, Mizuho Shibata, Tomohiro Ueda, Kensei Ishizu, Kenshiro Yokoi, and Sadao Kawamura, “Numerical and Experimental Analysis of Portable Underwater Robots with a Movable Float Device”, Journal of Robotics and Mechatronics Vol. 33 No. 6, 2021

### SUMMARY OF THE INVENTION

In an underwater robot including a float for posture control as in the above-described conventional technique, it is desired to implement appropriate posture control regardless of a working environment. However, for example, under an environment of a bad condition such as a large tidal current or a large number of obstacles, the float cannot be driven against an external force of the tidal current, or the float comes into contact with the obstacle, so that it might be difficult to execute appropriate posture control.

Conventionally, as a mechanism that moves a moving member such as a float by two-dimensional translation motion, a power transmission mechanism including two independent power sources is known. In an underwater robot equipped with such power transmission mechanism, for example, in a case of a constitution in which each power source moves together with the moving member, the center of buoyancy and the center of gravity tend to fluctuate, and it might be difficult to execute appropriate posture control.

For example, in a case where a power source that is a heavy object moves in a state in which the float is moved by posture control, large buoyancy is required, and the center of gravity might easily fluctuate together with the center of buoyancy. For example, in a case where the power source that serves as the float moves in a state in which a weight such as a counter weight is moved by posture control, a large weight is required, and the center of buoyancy might easily fluctuate together with the center of gravity.

An object of an aspect according to the present invention is to provide a robot capable of executing appropriate posture control.

In order to solve the above problem and achieve the object, the present invention adopts an aspect described below.

A robot according to an aspect of the present invention includes a first portion and a second portion coupled to each other, in which the second portion includes a moving member that is moved to change at least any of a center of buoyancy or a center of gravity of the first portion and the second portion as a whole, and a drive unit that moves the moving member by two-dimensional translation motion, and the drive unit includes a power source that outputs power for moving the moving member and is fixed to the first portion.

### BRIEF DESCRIPTION OF THE DRAWINGS

FIG. 1 is a perspective view illustrating a constitution of a robot of an embodiment of the present invention;

FIG. 2 is an exploded perspective view illustrating a constitution of a second position of the robot of the embodiment of the present invention;

FIG. 3 is a plane view illustrating a constitution of a drive unit of the robot of the embodiment of the present invention; and

FIG. 4 is a schematic diagram illustrating an operation example of a transmission mechanism of the robot of the embodiment of the present invention.

### DETAILED DESCRIPTION OF THE INVENTION

Hereinafter, a robot according to an embodiment of the present invention will be described with reference to the accompanying drawings. A robot 10 of the embodiment is, for example, an unmanned undersea vehicle (UUV), an unmanned surface vehicle (USV) or the like, which is an unmanned moving body on and under water. For example, the UUV, which is an unmanned submersible, includes a remotely operated vehicle (ROV), an autonomous underwater vehicle (AUV) and the like. For example, the ROV includes a so-called underwater drone and the like.

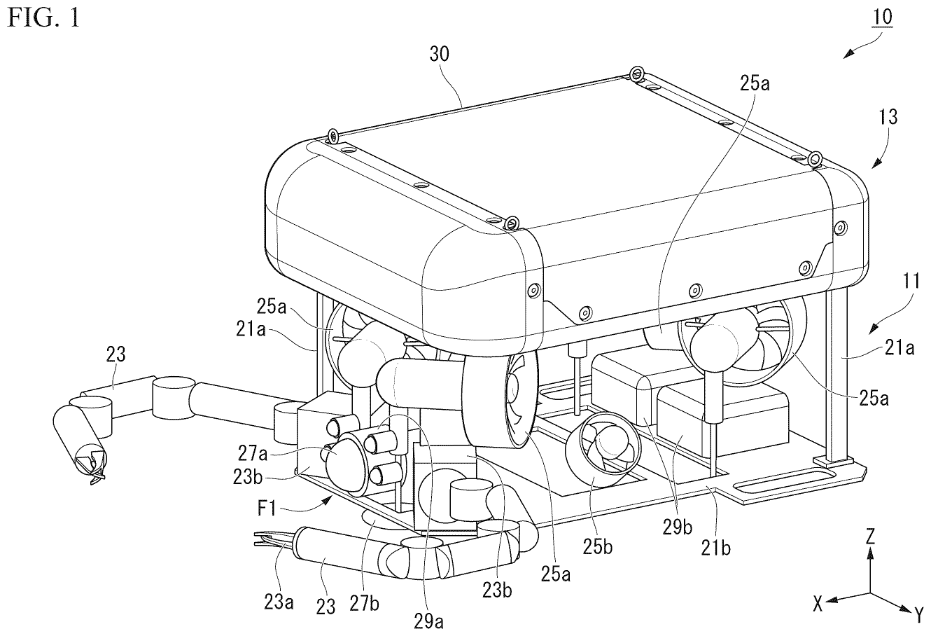

FIG. 1 is a perspective view illustrating a constitution of the robot 10 of the embodiment.

Hereinafter, axial directions of an X-axis, a Y-axis, and a Z-axis orthogonal to one another in a three-dimensional space are directions parallel to the respective axes. For example, as illustrated in FIG. 1, the X-axis direction is parallel to a front-rear direction of the robot 10, the Y-axis direction is parallel to a left-right direction of the robot 10, and the Z-axis direction is parallel to an up-down direction of the robot 10. For example, a positive direction of the X-axis is a forward direction of the robot 10, a positive direction of the Y-axis is a leftward direction of the robot 10, and a positive direction of the Z-axis is an upward direction of the robot 10.

As illustrated in FIG. 1, the robot 10 includes a lower first portion 11 and an upper second portion 13 coupled to each other.

The first portion 11 includes, for example, a plurality of coupling members 21a and a frame member 21b forming a first frame F1. An outer shape of each of the plurality of coupling members 21a is, for example, a columnar shape extending in the up-down direction and the like. The plurality of coupling members 21a is fixed to, for example, corners and the like of the frame member 21b and coupled to the second portion 13 to be described later. An outer shape of the frame member 21b is, for example, a ladder shape having a rectangular frame shape and the like. The frame member 21b supports, for example, various devices mounted on the first portion 11.

The first portion 11 includes, for example, two mechanical arms 23, four first thrusters 25a and two second thrusters 25b, a camera system 27a and a sensor 27b, and one front side control unit 29a and two rear side control units 29b.

Proximal ends of the two mechanical arms 23 are fixed to left and right corners of a front portion of the frame member 21b. Each mechanical arm 23 is, for example, a manipulator, and includes a hinge (joint) driven by an actuator and a plurality of beams (links) connected by the hinge (joint). Each mechanical arm 23 includes, for example, an end effector (hand) 23a that is provided at a distal end thereof and performs various works such as gripping and moving of an object. Each mechanical arm 23 includes a power device 23b that outputs power for operation at the proximal end thereof. Each mechanical arm 23 is arranged, for example, on an inner side of left and right ends of the frame member 21b when stopping, and allows the distal end thereof to protrude outward (forward and the like) of the robot 10 when operating.

The four first thrusters 25a are arranged in such a manner that two of them are arranged left and right in each of the front portion and a rear portion of the frame member 21b, for example.

The two second thrusters 25b are arranged left and right in the center portion in the front-rear direction of the frame member 21b, for example.

Each first thruster 25a is a so-called azimuth thruster. Each first thruster 25a includes, for example, a support that rotates about a first rotation axis in the up-down direction, and a propeller that is supported by the support and rotates about a second rotation axis orthogonal to the first rotation axis. Each first thruster 25a generates thrust in a direction orthogonal to the up-down direction, for example.

Each second thruster 25b includes, for example, a propeller that rotates about a rotation axis inclined at an acute angle with respect to the up-down direction. Each second thruster 25b generates thrust in a direction at least including the up-down direction, for example.

The camera system 27a is arranged in the center portion in the left-right direction in the front portion of the frame member 21b, for example. The camera system 27a includes, for example, a camera that images the outside on the front side of the robot 10 and a plurality of lighting bodies that illuminates the outside on the front side of the robot 10.

The sensor 27b is arranged in a portion below the camera system 27a in the front portion of the frame member 21b, for example. The sensor 27b is, for example, a Doppler velocity log (DVL) and the like that detects a relative velocity on the basis of sound wave radiation and detection of a reflected wave and a scattered wave.

The one front side control unit 29a is arranged in a portion behind the camera system 27a in the front portion of the frame member 21b, for example.

The two rear side control units 29b are arranged left and right in the rear portion of the frame member 21b, for example.

Each of the control units 29a and 29b includes, for example, a box-shaped housing that seals the inside in a sealed state, and a power supply, an electronic control unit and the like arranged inside the housing. Each of the control units 29a and 29b controls, for example, an operation of each mechanical arm 23, each of the thrusters 25a and 25b, the camera system 27a, the sensor 27b, and a drive unit 40 of the second portion 13 to be described later.

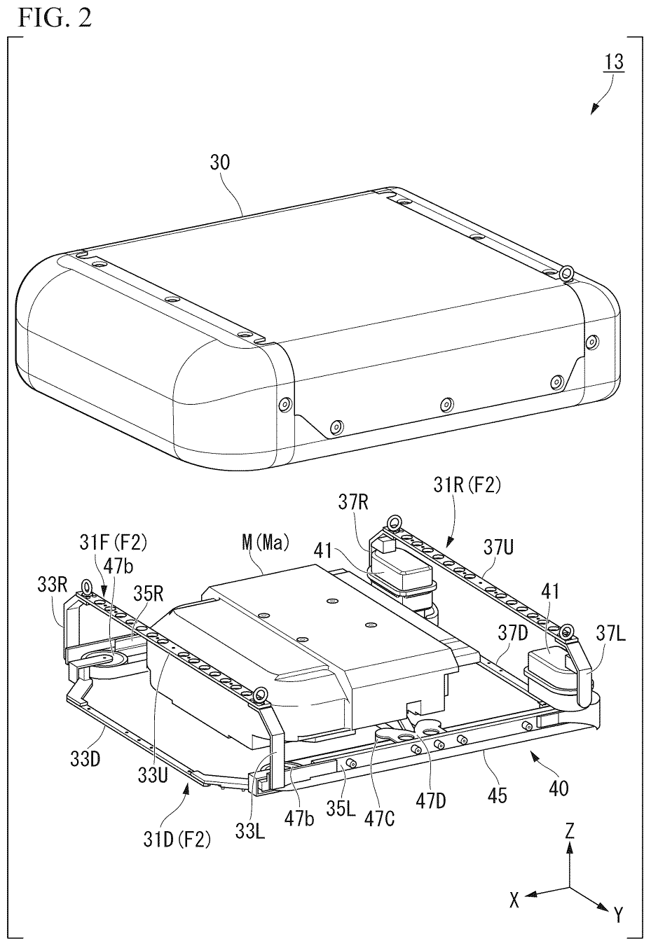

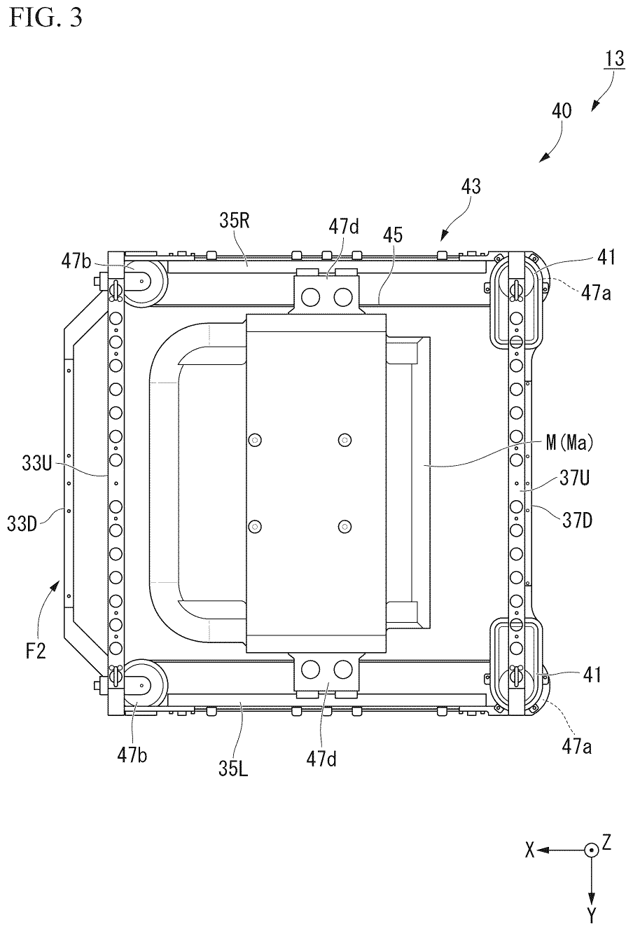

FIG. 2 is an exploded perspective view illustrating a constitution of the second portion 13 of the robot 10 of the embodiment. FIG. 3 is a plane view illustrating a constitution of the drive unit 40 of the robot 10 of the embodiment.

As illustrated in FIGS. 2 and 3, the second portion 13 includes a cover member 30, a second frame F2 covered with the cover member 30, a moving member M, and the drive unit 40.

The cover member 30 has an outer shape in, for example, a rectangular box shape, and includes a surface on which a plurality of through holes for allowing the inside and the outside to communicate with each other is formed. The cover member 30 is fixed to the second frame F2.

For example, the second frame F2 is fixed to the plurality of coupling members 21a of the first frame F1 and supports the cover member 30 and the drive unit 40.

The second frame F2 includes, for example, a lower frame 31D, and a front frame 31F and a rear frame 31R formed in a front portion and a rear portion, respectively, of the lower frame 31D. The lower frame 31D includes, for example, a front lower member 33D extending in the left-right direction, a left member 35L and a right member 35R extending in the front-rear direction, and a rear lower member 37D extending in the left-right direction, which are sequentially coupled rearward from the front. The front frame 31F includes, for example, a front lower member 33D, a front left member 33L and a front right member 33R extending in the up-down direction, and a front upper member 33U extending in the left-right direction, which are sequentially coupled upward from below. The rear frame 31R includes, for example, a rear lower member 37D, a rear left member 37L and a rear right member 37R extending in the up-down direction, and a front upper member 37U extending in the left-right direction, which are sequentially coupled upward from below.

The moving member M includes, for example, a buoyancy member Ma that generates buoyancy. The moving member M is moved by the drive unit 40 inside the cover member 30 in order to change at least any of the center of buoyancy or the center of gravity of an entire robot 10. The moving member M is moved to maintain, change or the like a posture of the robot 10, for example, when the robot 10 moves, when each mechanical arm 23 operates and the like.

The drive unit 40 includes, for example, two power sources 41 and a transmission mechanism 43.

The power source 41 is, for example, an electric motor. The two power sources 41 are fixed to left and right corners in the rear portion of the lower frame 31D, for example. The two power sources 41 supply power for moving the moving member M to the transmission mechanism 43.

The transmission mechanism 43 is not necessarily fixed to the lower frame 31D, for example.

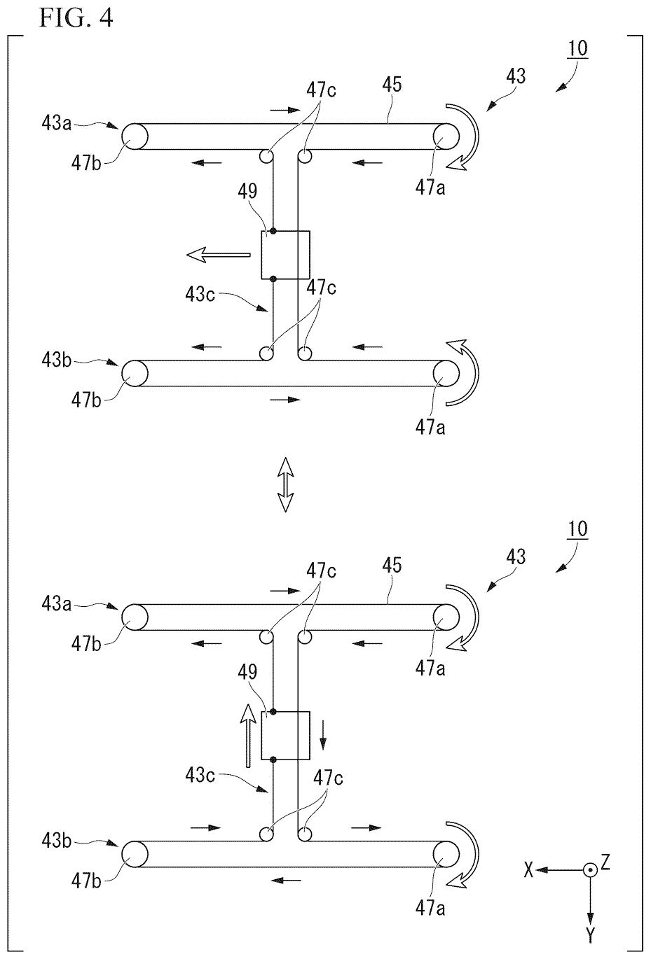

FIG. 4 is a schematic diagram illustrating an operation example of the transmission mechanism 43 of the robot 10 of the embodiment.

As illustrated in FIGS. 2, 3, and 4, the transmission mechanism 43 is, for example, a mechanism that moves the moving member M by two-dimensional translation motion in a two-dimensional orthogonal coordinate system of the X-axis and the Y-axis. The transmission mechanism 43 is, for example, a so-called H-BOT or H-type gantry robot.

The transmission mechanism 43 includes, for example, an annular member 45 arranged so as to form an H-shaped circling path including a first path portion 43a and a second path portion 43b arranged in parallel to each other, and a third path portion 43c connected to each of the first path portion 43a and the second path portion 43b orthogonally. For example, each of the first path portion 43a and the second path portion 43b is provided to reciprocate in parallel in the front-rear direction, and the third path portion 43c is provided to reciprocate in parallel in the left-right direction. The annular member 45 is, for example, a serpentine belt (meandering belt) formed by a so-called endless annular belt. The annular member 45 is arranged so as to meander along the circling path on the same plane (for example, the same XY plane), for example.

The transmission mechanism 43 includes, for example, two sets of driving pulleys 47a and driven pulleys 47b, four bend pulleys 47c, two pulley supports 47d, and a support member 49.

For example, the two sets of driving pulleys 47a and driven pulleys 47b include one set of driving pulley 47a and driven pulley 47b fixed to both ends of the first path portion 43a and to which the annular member 45 is attached, and one set of driving pulley 47a and driven pulley 47b fixed to both ends of the second path portion 43b and to which the annular member 45 is attached.

Rotation axes of the driving pulley 47a and the driven pulley 47b are parallel to the Z-axis direction. Each of the driving pulley 47a and the driven pulley 47b, for example, reverses a direction of the annular member 45 so as to turn back in the front-rear direction. The rotation axis of each driving pulley 47a is coupled to an output shaft of each power source 41. Each driving pulley 47a is rotationally driven about each rotation axis by the power of each power source 41. Each driving pulley 47a transmits the power of each power source 41 to the annular member 45 to drive the annular member 45 along each of the path portions 43a, 43b, and 43c. Each driven pulley 47b is rotated about each rotation axis by power transmitted from the annular member 45.

For example, the four bend pulleys 47c include two bend pulleys 47c arranged side by side in the front-rear direction between the first path portion 43a and the third path portion 43c and to which the annular member 45 is attached, and two bend pulleys 47c arranged side by side in the front-rear direction between the second path portion 43b and the third path portion 43c and to which the annular member 45 is attached. The rotation axis of each bend pulley 47c is parallel to the Z-axis direction. Each bend pulley 47c, for example, changes the direction of the annular member 45 to an orthogonal direction between the front-rear direction and the left-right direction.

For example, the two pulley supports 47d include one pulley support 47d that supports the two bend pulleys 47c arranged at a predetermined interval in the front-rear direction on the first path portion 43a side and one pulley support 47d that supports the two bend pulleys 47c arranged at a predetermined interval in the front-rear direction on the second path portion 43b side.

For example, the power transmitted from the annular member 45 to the four bend pulleys 47c drives the four bend pulleys 47c and the two pulley supports 47d in a first operation state, a second operation state, or a third operation state. For example, the first operation state is a state in which the two driving pulleys 47a rotate in different directions from each other, the state in which the two pulley supports 47d are moved in the front-rear direction together with the four bend pulleys 47c while stopping the rotation of the four bend pulleys 47c about the respective rotation axes. For example, the second operation state is a state in which the two driving pulleys 47a rotate in the same direction, the state in which the four bend pulleys 47c are rotated about the respective rotation axes while maintaining the positions in the front-rear direction of the two pulley supports 47d constant. For example, the third operation state is a state in which only one of the two driving pulleys 47a rotates, the state in which the two pulley supports 47d are moved in the front-rear direction together with the four bend pulleys 47c while allowing the four bend pulleys 47c to rotate about the respective rotation axes.

For example, the support member 49 is fixed to a single portion (that is, only one of a forward route or a backward route) of the annular member 45 in the third path portion 43c to support the moving member M.

For example, the support member 49 moves in the front-rear direction in the first operation state, moves in the left-right direction in the second operation state, and moves in an oblique direction with respect to each of the front-rear direction and the left-right direction in the third operation state by the power of each power source 41 transmitted via the annular member 45. For example, the support member 49 moves forward in the front-rear direction in the first operation state illustrated in FIG. 4, and moves rightward in the left-right direction in the second operation state illustrated in FIG. 4. For example, the support member 49 moves diagonally forward right in the third operation state in which only the driving pulley 47a of the second path portion 43b in the first operation state or the second operation state illustrated in FIG. 4 stops.

As described above, according to the robot 10 of the embodiment, since the power source 41 is fixed, for example, it is unnecessary to secure a space required for movement of a signal line, a power line and the like connected to the power source 41, and it is possible to increase the size of the moving member M and the buoyancy member Ma for ease of control of the center of buoyancy and the center of gravity. Since the power source 41 does not move together with the moving member M and the buoyancy member Ma, it is possible to suppress fluctuations in the center of buoyancy and the center of gravity and to improve ease of control of the center of buoyancy and the center of gravity.

For example, in a case of moving a unit of which buoyancy is larger than its weight, as the buoyancy is larger than the weight, an amount of movement required for a float decreases, so that it is possible to secure quick responsiveness such as quickly returning a machine body to its original posture or a desired posture against disturbance such as a tidal current that tilts the machine body. That is, it is more preferable that the moving member M includes the buoyancy member Ma that does not form a heavy object, and drive units such as the power source 41 and the transmission mechanism 43 that are heavy objects are fixed.

By including the cover member 30, for example, even in a case where the velocity of a relative flow of water becomes high due to a water flow caused by the ocean current, the tidal current and the like, a motion state of the robot 10 or the like, or under an environment of a bad condition with a large number of obstacles, a torque capacity of the drive unit 40 can be reduced, and it is possible to prevent difficulty in executing posture control. It is possible to suppress an increase in fluid resistance of the moving member M and the drive unit 40, to suppress an increase in power required for driving the moving member M and the drive unit 40, and to suppress an increase in size of the power supply and the power source 41.

In the transmission mechanism 43 of a so-called H-BOT or H-type gantry robot, the annular member 45 is arranged so as to meander on the circling path on the same plane, so that it is possible to suppress an increase in space required for arrangement of the transmission mechanism 43 as compared with, for example, a case where the annular members 45 are stacked in two stages or the like in the Z-axis direction.

Since it is possible to suppress a decrease in space for the movement of the moving member M, for example, by arranging the moving member M and the drive unit 40 on the rear side in response to the change in the center of buoyancy and the center of gravity due to the operation of each mechanical arm 23 in the front portion of the robot 10, it is possible to increase a movable amount of the moving member M in the front-rear direction and to improve the ease of control of the center of buoyancy and the center of gravity.

### (Modification)

Hereinafter, a modification of the embodiment will be described. The same parts as those in the above-described embodiment are denoted by the same reference numbers, and the description thereof will be omitted or simplified.

In the embodiment described above, the transmission mechanism 43 that performs two-dimensional translation motion is a so-called H-BOT or H-type gantry robot, but is not limited thereto. For example, the transmission mechanism 43 may be a mechanism including a power source fixed to at least a second frame F2, that is, a power source that does not move on a power transmission path and the like at the time of power transmission. For example, the transmission mechanism including a fixed power source other than the H-BOT may be a transmission mechanism such as so-called CoreXY or so-called T-BOT.

The so-called CoreXY transmission mechanism includes, for example, a first belt driven by a first power source for the X-axis and a second belt driven by a second power source for the Y-axis. The first belt and the second belt intersect each other, so that they are arranged in two stages in such a manner that positions in the Z-axis direction are different.

A so-called T-BOT transmission mechanism includes, for example, one belt driven by two power sources, a support member that moves in the Y-axis direction by power transmitted from the belt, a guide member that guides movement of the support member in the Y-axis direction, and an arm member that moves in the X-axis direction by power transmitted from the belt while being supported and guided by the support member. The guide member and the arm member of the support member are arranged in two stages in such a manner that positions in the Z-axis direction are different.

According to the above-described embodiment, the following configurations and advantageous effects can be achieved.

(1): The robot 10 includes the first portion 11 and the second portion 12 coupled to each other, in which the second portion includes the moving member M that is moved to change at least any of the center of buoyancy or the center of gravity of the first portion 11 and the second portion 12 as a whole, and the drive unit 40 that moves the moving member M by two-dimensional translation motion, and the drive unit 40 includes the power source 41 that outputs power for moving the moving member M and is fixed to the first portion 11.

According to the configuration (1) described above, since the power source 41 is fixed, for example, it is unnecessary to secure a space required for movement of a signal line and a power line connected to the power source 41, and it is possible to increase the size of the moving member M for ease of control of the center of buoyancy and the center of gravity. Since the power source 41 does not move together with the moving member M, it is possible to suppress fluctuations in the center of buoyancy and the center of gravity and to improve ease of control of the center of buoyancy and the center of gravity.

(2) In the configuration (1) described above, the moving member M may include the buoyancy member Ma that generates buoyancy.

In a case of the configuration (2) described above, the power source 41 does not move together with the buoyancy member Ma, it is possible to suppress fluctuations in the center of buoyancy and the center of gravity and to improve ease of control of the center of buoyancy and the center of gravity.

(3): In the configuration (2) described above, the second portion 12 may include the cover member 30 that entirely covers the moving member M and the drive unit 40.

In a case of the configuration (3) described above, for example, even in a case where the velocity of a relative flow of water becomes high due to a water flow caused by an ocean current, a tidal current and the like, a motion state of the robot 10 and the like, or under an environment of a bad condition with a large number of obstacles, a torque capacity of the drive unit 40 can be reduced by the cover member 30, and it is possible to prevent difficulty in executing posture control. It is possible to suppress an increase in fluid resistance of the moving member M and the drive unit 40, to suppress an increase in power required for driving the moving member M and the drive unit 40, and to suppress an increase in size of the power supply and the power source 41.

(4): In any one of the configurations (1) to (3) described above, the drive unit 40 may include the transmission mechanism 43 that transmits power output from the power source to the moving member M, the transmission mechanism 43 may include the annular member 45 arranged so as to form an H-shaped circling path including the first path portion 43a and the second path portion 43b arranged in parallel to each other, and the third path portion 43c connected to each of the first path portion 43a and the second path portion 43b orthogonally, two sets of the drive pulleys 47a and the driven pulleys 47b fixed to both ends of each of the first path portion 43a and the second path portion 43b and to which the annular member 45 is attached, the four bend pulleys 47c to which the annular member 45 is attached between each of the first path portion 43a and the second path portion 43b and the third path portion 43c, the bend pulleys 47c moving along each of the first path portion 43a and the second path portion 43b, and the support member 49 that is fixed to a single portion of the annular member 45 in the third path portion 43c, supports the moving member M, and moves along each of the first path portion 43a and the second path portion 43b or the third path portion 43c.

In a case of the configuration (4) described above, in the transmission mechanism 43 of a so-called H-BOT or H-type gantry robot, the annular member 45 is arranged so as to meander on the circling path on the same plane, so that it is possible to suppress an increase in space required for arrangement of the transmission mechanism 43 as compared with, for example, a case where the annular members 45 are stacked in two stages or the like.

The embodiment of the present invention has been presented by way of example, and there is no intention of limiting the scope of the invention. These embodiments can be implemented in various other forms, and various omissions, substitutions, and changes can be made without departing from the gist of the invention. These embodiments and modifications are included in the scope and gist of the invention, and are also included in the invention described in claims and the equivalent scope thereof.

What is claimed is:

1. A robot comprising:
a first portion and a second portion coupled to each other,
wherein
the second portion includes:
a moving member that is moved to change at least any of a center of buoyancy or a center of gravity of the first portion and the second portion as a whole; and
a drive unit that moves the moving member by two-dimensional translation motion, and
the drive unit includes a power source that outputs power for moving the moving member and is fixed to the first portion.

2. The robot according to claim 1, wherein
the moving member includes a buoyancy member that generates buoyancy.

3. The robot according to claim 2, wherein
the second portion includes a cover member that entirely covers the moving member and the drive unit.

4. The robot according to claim 1,
wherein
the drive unit includes a transmission mechanism that transmits power output from the power source to the moving member,
the transmission mechanism includes:
an annular member arranged so as to form an H-shaped circling path including a first path portion and a second path portion arranged in parallel to each other, and a third path portion connected to each of the first path portion and the second path portion orthogonally;
two sets of drive pulleys and driven pulleys fixed to both ends of each of the first path portion and the second path portion and to which the annular member is attached;
four bend pulleys to which the annular member is attached between each of the first path portion and the second path portion and the third path portion, the bend pulleys moving along each of the first path portion and the second path portion; and
a support member that is fixed to a single portion of the annular member in the third path portion, supports the moving member, and moves along each of the first path portion and the second path portion or the third path portion.
